(19) United States
(12) Patent Application Publication
(10) Pub. No.: US 2017/0056286 A1
(43) Pub. Date: Mar. 2, 2017

(54) SAUNA EQUIPMENT IMPROVING A STRUCTURE

(71) Applicant: Seung Woo LEE, (US)

(72) Inventor: Seung Woo LEE, Yorba Linda, CA (US)

(21) Appl. No.: 14/877,287

(22) Filed: Oct. 7, 2015

(30) Foreign Application Priority Data
Aug. 25, 2015 (KR) 20-2015-0005676

(51) Int. Cl. A61H 33/00; A61H 33/06

(52) U.S. Cl. CPC A61H 33/6005; A61H 33/066; A61H 2033/061; A61H 2203/0425

(57) ABSTRACT

A invention provides a sauna equipment comprising: a sauna equipment main body comprising a receiving portion and an opening portion; a fixed cover configured for closing a top front of the receiving portion of the sauna equipment main body; a movable cover comprising a sliding portion and a rotating portion; and a door installed rotatably in the sauna equipment main body, and the invention further comprises a hinge member comprising a first hinge installed at one side of the sliding portion of the movable cover, a second hinge installed at one side of the rotating portion of the movable cover, and a connecting member having one side installed in the first hinge and another side installed in the second hinge, and installed rotatably in the sliding portion of the movable cover through the first hinge and installed rotatably in the rotating portion of the movable cover through the second hinge.

### FIELD OF TECHNOLOGY

The present invention relates to a sauna, more specifically to a ‘sauna equipment having an improvement’, which enables to enjoy sauna stably due to the improved structures.

### BACKGROUND OF INVENTION

In general, sauna is known as a method for facilitating health by removing waste accumulated in a body outside the body within a short period of time for recovery from fatigue and skin health.

Such a sauna is for forceful sweating by applying to the body heat usually over 40° C. in a sealed space, and many sauna products for usage at home have been on the market.

FIGS. 1 and 2 are perspective views showing conventional sauna equipment in different views, and the conventional sauna equipment is going to be described briefly referring to FIGS. 1 and 2.

The conventional sauna equipment includes a sauna main body (10), a fixed cover (20), a movable cover (30), and a door (40).

The sauna equipment main body (10) provides receiving portion (11) opened upwards and a opening portion (12) formed so as to open laterally at one side surface and to be connected to the receiving portion (11). The conventional sauna equipment further includes another opening portion (12) on other side surface of the sauna equipment main body (10).

The fixed cover (20) closes a top front of the receiving portion (11) of the sauna equipment main body (10).

The movable cover (30) provides a sliding portion (31) installed slidingly to the sauna equipment main body (10) so as to be inserted to and released from a bottom portion of the fixed cover (20) and a rotating portion (32) having a round shape opened upwards, downwards, and rearwards and installed at one side of the sliding portion (31) rotatably upwards and downwards, and open-and-closes a top rear of the receiving portion (11) of the sauna equipment main body (10).

The door (40) is installed rotatably in the sauna equipment main body (10), so as to open and close the opening portion (12) of the sauna equipment main body (10).

Also, in general, the conventional sauna includes heater, far-infrared lamp, control unit, etc. for operating the sauna equipment in addition to the above.

On the other hand, in the sauna equipment an in the above, the sliding portion (31) of the movable cover (30) is slided and inserted to a lower portion of the fixed cover (20), the rotating portion (32) of the movable cover (30) is rotated, and a top portion of the receiving portion (11) of the sauna equipment main body (10) is open-and-closed, so that a user enters and exits the receiving portion (11) of the sauna equipment main body (10).

However, in the case of the conventional sauna equipment, if the user rotates the rotating portion (32) of the movable cover (30) in a state that the sliding portion (31) of the movable cover (30) is inserted to a lower portion of the fixed cover (20), as shown in FIG. 3, the top surface of the rotating portion (32) of the movable cover (30) contacts and is supported by a side surface of the fixed cover (20), being raised in a specific angle.

Then, since the rotating portion (32) of the movable cover (30) is raised, the user entering the sauna equipment through the opening portion (12) of the sauna equipment main body (10) holds the rotating portion (32) of the movable cover (30) with a hand subconsciously. Then, the rotating portion (32) of the movable cover (30) receives a pressure, and the pressing force is delivered to the sliding portion (31) of the movable cover (30) and to the connecting portion of the rotating portion (32), resulting a problem that the movable cover (30) is damaged easily. Also, as the movable cover (30) is damaged, the user may fall down, incurring a serious safety problem.

### PRIOR ART DOCUMENTS

### Patent Literature

Korean Patent No. 20-0349944

### INVENTION

### Problems to Solve

The invention is to solve the above problems and provide a ‘sauna equipment having an improvement’, which enables to enjoy sauna stably by improving structures.

### Solutions to Problems

In order to solve the above problems, a sauna equipment according to the invention comprises:

a sauna equipment main body comprising a receiving portion opened upwards and an opening portion formed so as to be opened sideways at a side surface and connected with the receiving portion;

a fixed cover configured for closing a top front of the receiving portion of the sauna equipment;

a movable cover configured for open-and-closing a top rear of the receiving portion of the sauna equipment main body and comprising a sliding portion installed slidably at the sauna equipment main body so as to be inserted to and released from a lower portion of the fixed cover, a rotating portion formed with a round shape opened upwards, downwards, and rearwards and installed rotatably at a side of the sliding portion; and

a door installed rotatably in the sauna equipment main body and configured for open-and-closing the opening portion of the sauna equipment main body, and

further comprising a hinge member comprising a first hinge installed at one side of the sliding portion of the movable cover, a second hinge installed at one side of the rotating portion of the movable cover, and a connecting member having one side installed in the first hinge and another side installed in the second hinge, and installed rotatably in the sliding portion of the movable cover through the first hinge and installed rotatably in the rotating portion of the movable cover through the second hinge.

### Effects of Invention

The invention can prevent a movable cover from being damaged by the user entering a sauna equipment, by a rotating portion of the movable cover's providing a sliding portion, so that the rotating portion of the movable cover is disposed in parallel to the sliding portion of the movable cover.

Also, the sauna equipment according to the invention can prevent the user from breaking the movable cover and falling down, etc. while entering and exiting the sauna equipment, so that the user uses the sauna equipment much more safely.

### BRIEF DESCRIPTION OF DRAWINGS

FIGS. 1 and 2 are perspective views showing conventional sauna equipment in different views,

FIG. 3 is a diagram for explaining a conventional movable cover,

FIG. 4 is a partial cross-sectional view of a sauna equipment according to the invention,

FIG. 5 is a diagram showing a movable cover in FIG. 4,

FIG. 6 is a diagram showing an open disposition of a movable cover of a sauna equipment according to the invention, and

FIG. 7 is a diagram showing the movable cover in FIG. 6.

### DETAILED DESCRIPTION OF EMBODIMENTS OF INVENTION

Below, the invention is going to be described in detail referring to the attached drawings.

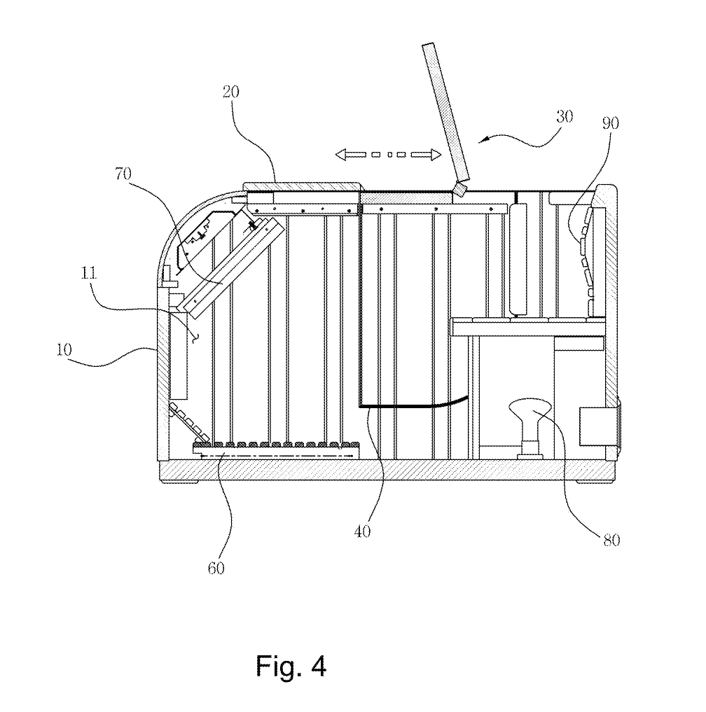

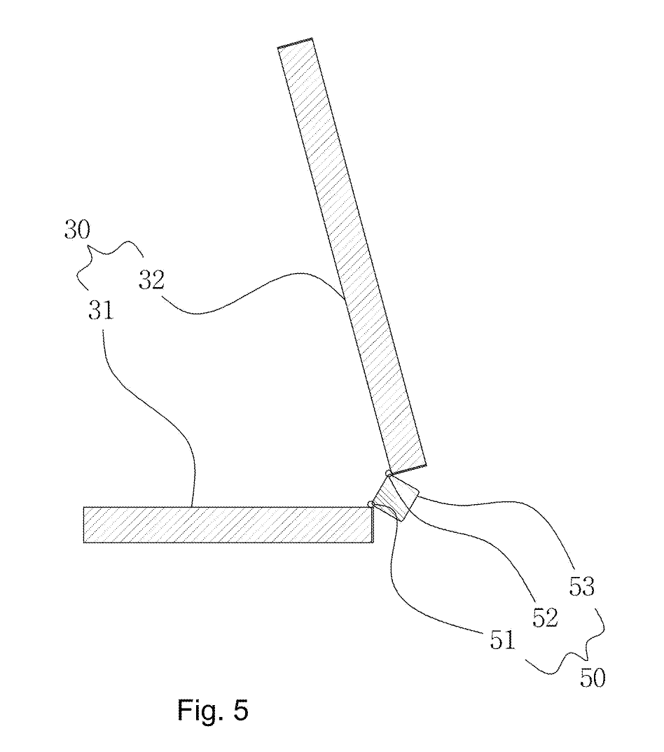

FIG. 4 is a partial cross-sectional view of a sauna equipment according to the invention, and FIG. 5 is a diagram showing a movable cover in FIG. 4, and referring to FIGS. 4 and 5, the sauna equipment according to the invention described below.

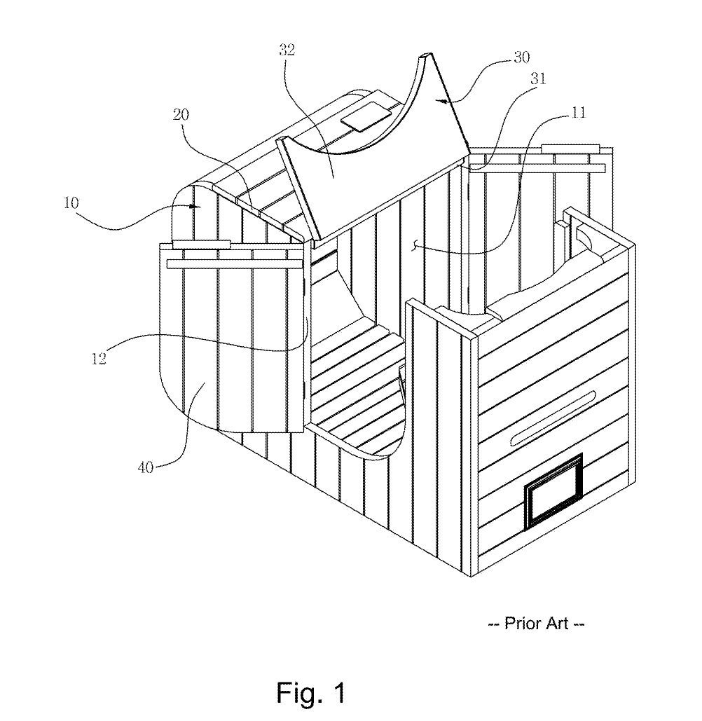

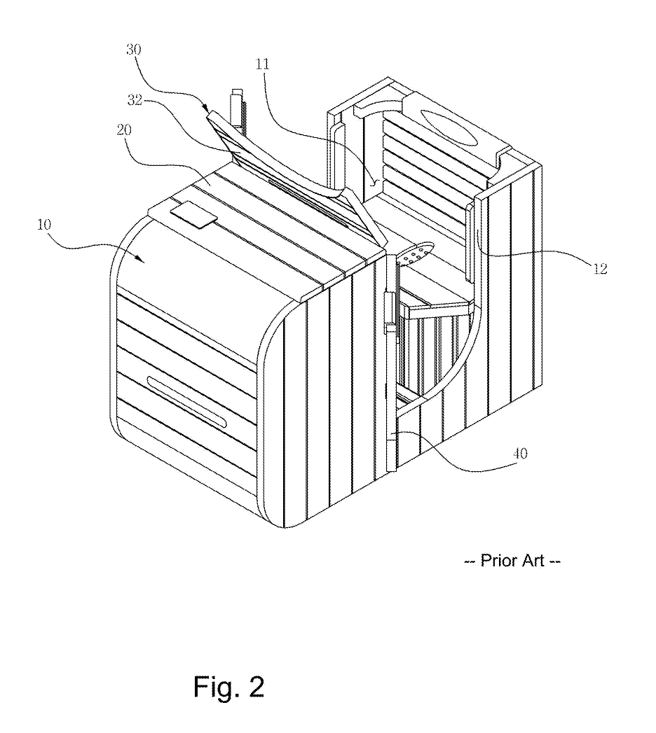

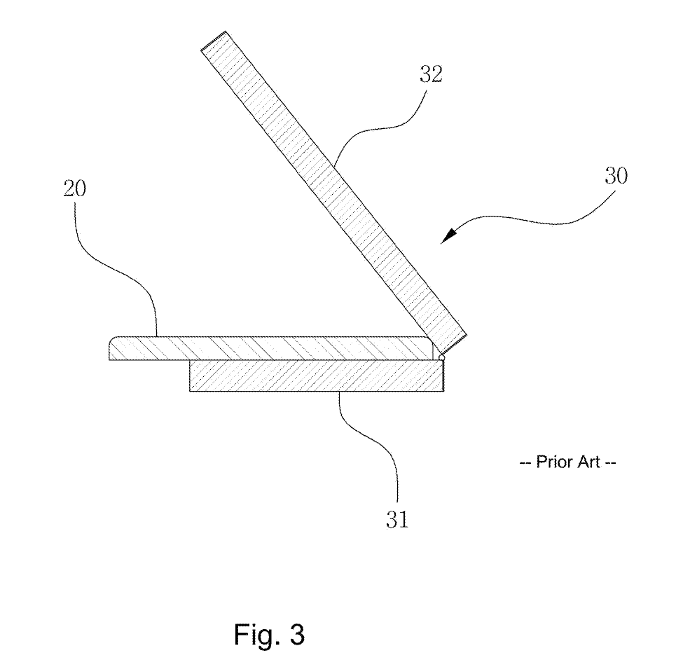

The sauna equipment according to the invention has some external structures similar to the conventional sauna equipment shown in FIGS. 1 to 3, but some changes and additions are applied to some of the parts. In describing the invention, structures similar to the conventional sauna equipment are assigned with same reference numerals.

The sauna equipment according to the invention basically provides a sauna equipment main body (10), a fixed cover (20), a movable cover (30), and a door (40) as in the conventional sauna equipment.

An invention provides a sauna equipment comprising: a sauna equipment main body (10) comprising a receiving portion (11) opened upwards and an opening portion (12) formed so as to be opened sideways at a side surface and connected with the receiving portion (11); a fixed cover (20) configured for closing a top front of the receiving portion (11) of the sauna equipment main body (10); a movable cover (30) configured for open-and-closing a top rear of the receiving portion (11) of the sauna equipment main body (10) and comprising a sliding portion (31) installed slidably at the sauna equipment main body (10) so as to be inserted to and released from a lower portion of the fixed cover (20), a rotating portion (32) formed with a round shape opened upwards, downwards, and rearwards and installed rotatably at a side of the sliding portion (31); and a door (40) installed rotatably in the sauna equipment main body (10) and configured for open-and-closing the opening portion (12) of the sauna equipment main body (10).

And the sauna equipment according to the invention further comprises a hinge member (50).

The hinge member (50) comprises a first hinge (51) installed at one side of the sliding portion (31) of the movable cover (30), a second hinge (52) installed at one side of the rotating portion (32) of the movable cover (30), and a connecting member (53) having one side installed in the first hinge (51) and another side installed in the second hinge (52), and installed rotatably in the sliding portion (31) of the movable cover (30) through the first hinge (51) and installed rotatably in the rotating portion (32) of the movable cover (30) through the second hinge (52).

In a case that the movable cover (30) is installed at a position where the receiving portion (11) of the sauna equipment main body (10) opens, the hinge member (50) enables the rotating portion (32) of the movable cover (30) to be folded completely.

On the other hand, the sauna equipment according to the invention further comprises a z60 provided on an internal floor of the sauna equipment main body (10) and configured for a user's foot to rest on, a z70 installed internally in the sauna equipment main body (10) and for supplying heat to the receiving portion (11) of the sauna equipment main body (10), a z80 installed internally in the sauna equipment main body (10), and a z90 installed internally in the sauna equipment main body (10). In this embodiment, the z60, the z70, the z80, and the z90 are well known to the community of sauna equipment. On the other hand, in this embodiment, a separate heater may be provided in the z90, and well-known structures used in sauna equipment may be added further.

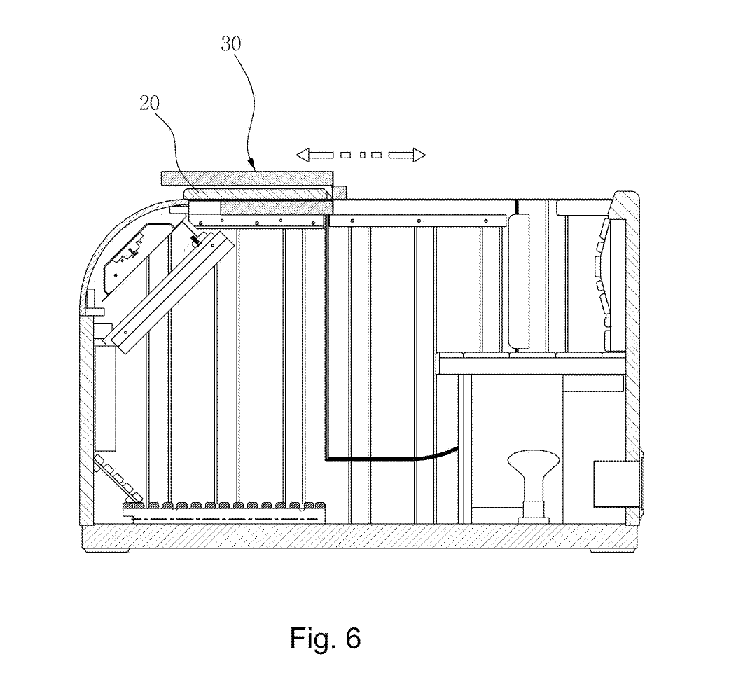

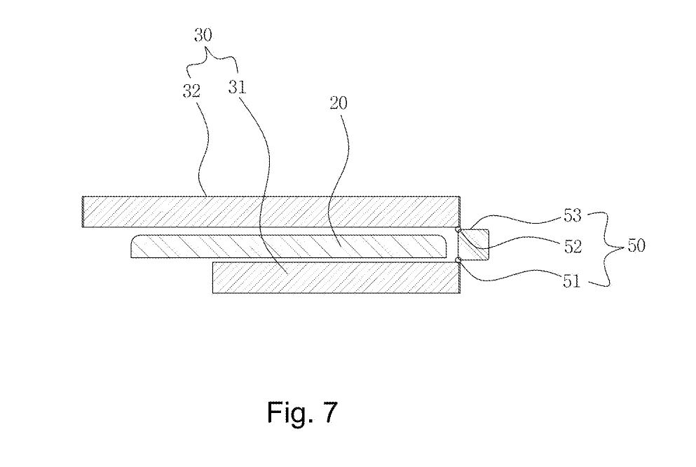

FIG. 6 is a diagram showing an open disposition of a movable cover of a sauna equipment according to the invention and FIG. 7 is a diagram showing the movable cover in FIG. 6, and states of usage of a sauna equipment according to the invention referring to FIGS. 6 and 7 below.

After finishing the usage of sauna, the user rotates the rotating portion (32) of the movable cover (30) counterclockwise to exit the sauna equipment. Then if the user pushes the movable cover (30) forwards, the sliding portion (31) of the movable cover (30) is inserted to a lower portion of the fixed cover (20).

Here, since the movable cover (30) is folded completely through the hinge member (50), as shown in FIGS. 6 and 7, the sliding portion (31) and the sliding portion (31) of the movable cover (30) are disposed in parallel to each other.

Next, the user comes out by opening the opening portion (12) of the sauna equipment main body (10), and since the rotating portion (32) of the movable cover (30) is not held up, the user does not hold the sliding portion (31) of the movable cover (30) unconsciously, so that any structural damage to the movable cover (30) by external force exerted by the user is prevented and when the user exits the sauna equipment any damage to the movable cover (30) and the user's falling down can be prevented.

On the other hand, the user's exiting the sauna equipment has been described in the above, but since even when entering the sauna equipment the user does not hold the rotating portion (32) of the movable cover (30), any structural damage to the movable cover (30) by external force exerted by the user is prevented and when the user exits the sauna equipment any damage to the movable cover (30) and the user's falling down can be prevented.

As described in the above, the sauna equipment according to the invention provides a hinge member (50) having a double-hinge structure, which makes the rotating portion (32) of the movable cover (30) and the sliding portion (31) of the movable cover (30) disposed in parallel with each other, so that a damage to the movable cover (30) by the user can be prevented when the user enters and exits the sauna equipment.

Also the sauna equipment according to the invention can prevent the movable cover (30) from being damaged and the user from falling down, so that the user can use the sauna equipment much more safely.

The descriptions of the invention in the above are just for embodiments of the invention. One skilled in the field of arts may change and modify the invention variously without leaving the spirit and scope of the invention claimed in the claims below.

[Reference Numerals]

| | |
|---|---|
| 10: sauna equipment main body | 11: receiving portion |
| 12: opening portion | 20: fixed cover |
| 20: movable cover | 21: sliding portion |
| 32: rotating portion | 40: door |
| 50: hinge member | 51: first hinge |
| 52: second hinge | 53: connecting portion |
| 60: floor heater | 70: internal heater |
| 80: far-infrared lamp | 90: backrest |

1. A sauna equipment comprising:
a sauna equipment main body comprising a receiving portion opened upwards and an opening portion formed so as to be opened sideways at a side surface and connected with the receiving portion;
a fixed cover configured for closing a top front of the receiving portion of the sauna equipment;
a movable cover configured for open-and-closing a top rear of the receiving portion of the sauna equipment main body and comprising a sliding portion installed slidably at the sauna equipment main body so as to be inserted to and released from a lower portion of the fixed cover and a rotating portion formed with a round shape opened upwards, downwards, and rearwards and installed rotatably at a side of the sliding portion; and
a door installed rotatably in the sauna equipment main body and configured for open-and-closing the opening portion of the sauna equipment main body, and
further comprising a hinge member comprising a first hinge installed at one side of the sliding portion of the movable cover, a second hinge installed at one side of the rotating portion of the movable cover, and a connecting member having one side installed in the first hinge and another side installed in the second hinge, and installed rotatably in the sliding portion of the movable cover through the first hinge and installed rotatably in the rotating portion of the movable cover through the second hinge.

2. The sauna equipment of claim 1, wherein the hinge member is made of a rectangular cylinder having a length substantially same as a width of the fixed cover or the movable cover.

3. The sauna equipment of claim 2, wherein the hinge member has a cross-section of a shape of square.

4. The sauna equipment of claim 3, wherein a side length of the square is substantially same as a thickness of the fixed cover.

5. The sauna equipment of claim 3, wherein a side length of the square is longer than a thickness of the fixed cover.

6. The sauna equipment of claim 3, wherein a side length of the square is substantially same as a thickness of the movable cover.

7. A sauna equipment comprising:
a sauna equipment main body comprising a receiving portion opened upwards and an opening portion formed so as to be opened sideways at a side surface and connected with the receiving portion;
a fixed cover configured for closing a top front of the receiving portion of the sauna equipment;
a movable cover configured for open-and-closing a top rear of the receiving portion of the sauna equipment main body and comprising a sliding portion installed slidably at the sauna equipment main body so as to be inserted to and released from a lower portion of the fixed cover and a rotating portion formed with a round shape opened upwards, downwards, and rearwards and installed rotatably at a side of the sliding portion; and
a hinge member comprising a first hinge installed at one side of the sliding portion of the movable cover, a second hinge installed at one side of the rotating portion of the movable cover, and a connecting member having one side installed in the first hinge and another side installed in the second hinge, and installed rotatably in the sliding portion of the movable cover through the first hinge and installed rotatably in the rotating portion of the movable cover through the second hinge.

8. The sauna equipment of claim 7, wherein the hinge member is made of a rectangular cylinder having a length substantially same as a width of the fixed cover or the movable cover.

9. The sauna equipment of claim 8, wherein the hinge member has a cross-section of a shape of square.

10. The sauna equipment of claim 9, wherein a side length of the square is substantially same as a thickness of the fixed cover.

11. The sauna equipment of claim 9, wherein a side length of the square is longer than a thickness of the fixed cover.

12. The sauna equipment of claim 9, wherein a side length of the square is substantially same as a thickness of the movable cover.

13. The sauna equipment of claim 7, further comprising a door installed rotatably in the sauna equipment main body and configured for open-and-closing the opening portion of the sauna equipment main body.
